(19) United States
(12) Patent Application Publication
(10) Pub. No.: US 2021/0267219 A1
(43) Pub. Date: Sep. 2, 2021

(54) Squeezeeta! Fresh Gourmet Dough Ready To Squeeze!

(71) Applicant: Laura Lombardo, Alcamo (IT)

(72) Inventor: Laura Lombardo, Alcamo (IT)

(21) Appl. No.: 16/580,928

(22) Filed: Sep. 24, 2019

Related U.S. Application Data
(60) Provisional application No. 62/735,901, filed on Sep. 25, 2018.

(51) Int. Cl. A21D 10/00; A21D 10/02; A21D 8/02; A21D 2/38; A21D 2/34; A21D 13/60

(52) U.S. Cl. CPC A21D 10/007; A21D 10/025; A21D 13/60; A21D 2/38; A21D 2/34; A21D 8/02

(57) ABSTRACT

Squeezeeta is a method of producing pizza dough more quickly and conveniently, for both consumers and manufacturers. It is particularly useful in manufacturing—enabling a shorter assembly line than in current set-ups, faster speeds, and reductions in energy consumption and cost of production. The method produces a packaged good in the form of a squeezable pizza dough in a pouch (sac-à-poche), marketable to both retail consumers and food services. The method can also be used for bread, pasta, croissant, crepes etc. Squeezeeta also enables consumers to create pizza at home from scratch, which is fully customizable in shape, size and crust thickness, and greatly surpasses competitors for freshness, quality and taste. Requiring no special expertise or professional pizza-maker skills, the Squeezeeta method also allows food services operations to achieve huge savings. The Squeezeeta method can be applied, with proper adjustments, to other popular dough-based products (including bread and pasta).

### CROSS REFERENCE TO PREVIOUS APPLICATIONS

This invention relates to a provisional application, filed on Sep. 25 of 2018, electronically via EFS-WEB. Provisional application n. 62735901; EFS ID 33815473; Confirmation n.7037

### FIELD OF THE INVENTION

Squeezeeta is an innovative product in a number of subsectors of the Food & Beverage sector. Firstly it is an innovation in the pizza subsector, where it is a distinct improvement—competitive on the grounds of cost, quality, flavour, convenience and ease- and speed-of-use—vis-à-vis the other major products in the market, including frozen pizza, prepared pizza crust, pizza dough balls and home pizza-making kits, and also in respect to home delivery of cooked pizza from pizzerias and restaurants. It is also an innovation in current manufacturing processes—for the production of a range of dough-based food products—as well as in the packaging, distribution and preparation of such products.

As such, Squeezeeta is a new and competitive innovation in the wider bakery industry, where it is an improvement on existing methods of manufacturing specialty breads and baked products, including focaccia, panzerotti, calzone, crepes, pancakes and indeed any grain-based product, utilizing any form of flour desired (white, whole wheat, rye, oats, chick pea, rice, millet etc.).

Squeezeeta is also an improved way of manufacturing a range of specialized food products designed for particular markets—such as gluten-free, vegan, variously spiced, ethnic, gourmet, party foods, easy snacks, and ready-to-eat meals—and is particularly suitable for families and children, novelty and specialty food producers and caterers, and those on restricted diets (whether for health, religious or other reasons), thanks to the ease, convenience, speed and inexpensiveness with which it can be variously personalized and customized in size, shape, crust, etc.

Squeezeeta represents a completely new concept in the food industry in general, overcoming as it does the traditional distinction between low-quality and low-priced fast food and high-quality, high-priced food that is much slower and more difficult to prepare. Squeezeeta by contrast is quick and easy to prepare, price-competitive with fast foods, yet can be prepared to the highest standards of flavour, nutrition and quality.

Squeezeeta is moreover a distinct improvement upon present methods of cooking all the above-named food items (pizza, focaccia, calzone, bread, crepes, etc.)—both by consumers in their homes, and by food service operations, including restaurants, caterers, institutions, etc. —with higher productivity and lower costs.

### BACKGROUND OF THE INVENTION

The invention of Squeezeeta was a response to a commonly felt need in North American society, as filtered through the peculiar cultural background and circumstances of a young, ambitious Sicilian immigrant: namely, myself—Laura Lombardo—the inventor in this application.

Coming to North America in my mid-20s, and struggling to combine work, school, social and professional networking and other essential and time-consuming projects, I found it nearly impossible to prepare good meals. Yet meal times and good food have always been very important to me, raised as I was in a close-knit, traditional extended family in Sicily. Food is a vital part of Sicilian life, and my mother and grandmother would create an infinite variety of delicious meals, from wholesome natural ingredients, often grown or produced by ourselves, our family or friends. Even the salt was produced locally by people we knew.

The traditional way of cooking pizza is quite time-consuming and it takes experience and skill to prepare it properly. One evening, very tired after a long day, I was mixing the traditional dough, and I made a mistake in the proportions of the ingredients. The result was much too fluid—my grandmother would have thrown the whole batch out. But I was too tired that evening, and in any case, not in a position to waste food. So I spread the mixture on the cooking pan anyway. I was pleasantly surprised at how well it spread, and, hoping for the best, I lay my ingredients (cheese, vegetables and sauce) on top, and slid the whole thing into the oven. The result, to my surprise, was a delicious pizza. I said as much to myself (in Italian): “Che squisita questa pizza!” And I suddenly realized that I had solved the problem I had been facing, and which millions of other young ambitious people face every day—the problem of preparing nutritious, delicious, high-quality food at home, quickly, easily and at an affordable cost. I had even stumbled upon a name for this concept (adapted for an English-language market): Squeezeeta.

Over the next weeks and months, I used all the spare time and money I had to experiment with the product—its production, preservation, preparation, and above all its packaging. [For detailed results of these experiments, see below: “Detailed Description”.] The end result was a product that combines the virtues of fast food with those of what has been called “slow food”—bringing the benefit of nutritious, personalized homemade food to millions of consumers who, up to now, have had to forego these benefits because of their shortage of time and money.

The Squeezeeta concept is also scalable to meet the needs of commercial food service, institutional, military or humanitarian operations, who also need to prepare food of the highest quality possible, yet quickly, easily and at an affordable cost.

### BRIEF SUMMARY

Squeezeeta is a method of producing pizza dough, particularly useful in manufacturing—enabling a shorter assembly line than in current set-ups, faster speeds, and reductions in energy consumption and cost of production. The Squeezeeta method can also be used to produce a packaged good in the form of a squeezable pouch (sac-à-poche) containing squeezable pizza dough, for both retail and commercial food services.

The same procedure applies for other staples doughs (for bread, pasta, croissant, brioches, crepes and sweets, etc.).

Squeezeeta is also a method of cooking pizza at home—faster, more easily and more fun—allowing total consumer customization in shape, size and crust thickness, and surpassing frozen pizza or pizza crusts for freshness, quality and taste. Since it requires no special expertise or professional pizza-making skill, the Squeezeeta method also enables food services to achieve huge savings in terms of time, labor-training and costs.

The same cooking procedure applies, with due adjustments, to other popular dough-based products (including bread and pasta).

### DETAILED DESCRIPTION

Squeezeeta is an innovative method of producing pizza-dough by manufacturers—one that reduces production time, and therefore costs. It also significantly shortens the assembly line (lowering energy consumption)—and reduces the number and complexity of industrial machines required, being rapidly installable in total automatic mode, without active employee intervention, further reducing production costs. Following, below, is a step-by-step illustration of such an improved production cycle.

Squeezeeta dough uses a higher proportion of water, relative to the other ingredients, compared to traditional recipes of pizza dough. Specifically, Squeezeeta pizza-dough is made with the basic pizza dough ingredients: flour, salt, yeast and water—yet, unlike in traditional recipes, the water represents 60-90% of the flour quantity. This figure represents total liquid content, in some cases including more than water alone. Sometimes, traditional pizza-dough recipes involve the addition of milk or beer or extra olive oil or other liquid components. In these cases, the percentage of water to add to the formula would be less than if the formula had fewer liquids, so that the amount of all liquid ingredients put together confer the proper level of fluidity, at a higher proportion than that of traditional doughs.

In fact, the ultimate constitutive factor of all Squeezeeta doughs is its viscosity, similar to that of a standard toothpaste: a squeezable dough, in a squeezable package. The concept of squeezable dough is not only a new way to conceive dough and to manufacture it, but also—as we will soon see—to package it—in a squeezable icing-pipe or sac-à-poche—and ultimately to prepare it for cooking, at home or in a commercial kitchen. And—to give here a brief flash-forward of what will be explained in detail below—these Squeezeeta advantages obtain in the production of all sorts of other bakery foods, such as pasta and bread dough.

To begin with pizza dough, then, the change in viscosity also enables a reduction in the amount of yeast required—to just 2 to 5 grams per kilogram of flour. In fact, it has been successfully demonstrated that Squeezeeta can be made with no yeast at all—making the product suitable and safe for yeast-allergic and other yeast-restricted diets, without sacrificing flavour and consumer enjoyment (quite unlike most other food products in this market segment).

This series of experiments into the yeast required further demonstrated that the product is suitable for the innovative packaging design envisioned in the Squeezeeta concept (see below for more details). The traditional proportion of yeast is unsuitable for many types of packaging, as the product will expand during shipping- and shelf-time, creating a risk of inconvenience to retailers or consumers. My experiments demonstrated that the innovative Squeezeeta recipe overcomes this inconvenience and eliminates the risk, without reducing the quality, flavour or performance of the product.

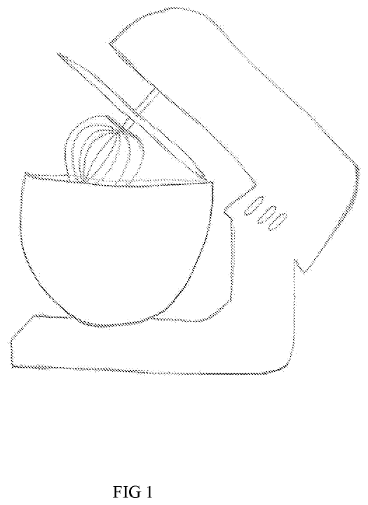

Once the ingredients have been added in the specified Squeezeeta proportions, the mixing process is performed in a single operation of several minutes [FIG. 1]. This is in stark contrast to current industrial methods of mixing pizza dough, which require complex (and expensive) aggregates of industrial parts, in order to release ingredients at different points in time during the mixing process. This adds significantly to the cost-efficiency of Squeezeeta—mixing is simpler and easier than with traditional pizza doughs, requiring a single machine, no specialized skills, less time and fewer steps, saving the manufacturer time, labor, capital and expense.

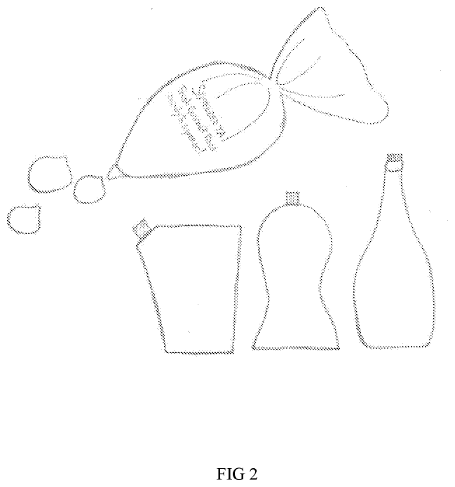

Once mixed, the Squeezeeta compound is packaged in squeezable pouches (or “sac-à-poche”, similar to the icing-pipe used to decorate a birthday cake), or other kind of squeezable package, through a second (and final) piece of equipment (the filling machine), and is already completely/packaged [FIG. 2]. The compound at this stage would be immediately suitable for consumption, even when additional spices or flavour ingredients are added. This is beyond the possibility of the current pizza-dough production cycles, which have to include time for leavening and rest. The complete range of Squeezeeta-method products all share this low-cost, higher-speed production process, enabling a lower price-point for consumers.

The result is a consistent compound with a level of fluidity and viscosity comparable to that of commercial toothpaste. Experiments have demonstrated the viability of a variety of packaging techniques designed to extend shelf-life—including hot fill (boiling the compound, filling the packaging and sealing, for maximum durability), packing and subsequent freezing, and packaging and subsequent refrigeration. In this latter case, freshness is preserved for up to 30 days, even in the absence of additional preservative ingredients. Experiments have shown that the addition of a wide range of chemical preservatives, as well as natural organic preservatives (as demonstrated in experiments using cultured organic starch) will extend shelf-life well beyond 30 days. If immediate packaging is not required, the compound can be kept frozen or refrigerated, until packaging is required. This feature makes Squeezeeta uniquely suitable for alternative forms of delivery to the consumer, for instance through self-service stores. In this case, consumers could fill their own packages at spouts delivering Squeezeeta (even choosing from a number of spouts for the type of Squeezeeta they prefer, such as regular, organic, whole wheat, gluten-free, etc.). The spouts would be fed by an irrigation system, not unlike that of beer “on tap” in a bar, which would bring the compound from a deposit tank.

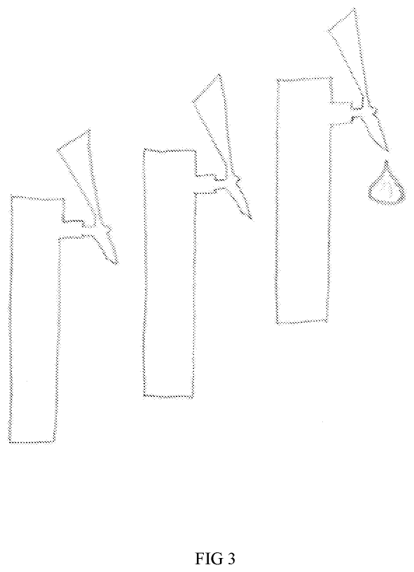

The innovative fluid nature of Squeezeeta is what enables this further innovation in consumer delivery and self-packaging. [FIG. 3] The compound in the deposit tank would be preserved and tested for freshness on a regular basis, enabling the process to be used in stores across a wide range of economic scale, from large grocery stores to small “boutique”-style shops. It would also be possible to deliver a home-style deposit tank directly to the consumer, who could then draw off the amount of Squeezeeta as and when they have immediate need for it, in a manner similar to systems currently used for home-filtered drinking water or home water cooler systems.

In addition, Squeezeeta provides an innovative method of production for other breads and specialty baked goods, including sandwich bread, bruschetta, focaccia, crepes, pancakes, calzone/panzerotti, the Sicilian chickpea fritter known as panelle, as well as a variety of pastries, salty snacks, croissants, brioches etc. For these products, Squeezeeta is prepared in the same basic way (in terms of mixing, fluid proportions, etc.) and gaining all the same advantages as a result, as for pizza dough. That is, the higher water content (adjusted somewhat for each individual product, as determined experimentally), a modified quantity of yeast (depending on product), and the same economical production process—i.e. one-step mixing, resulting in a fluid compound that is ready to consume, and can be packaged immediately according to the need for preservation (e.g. whether for food service production with immediate baking, or for consumer home baking requiring a sustained shelf-life).

This one-step mixing and immediate readiness to consume (bake) remains a feature of Squeezeeta regardless of the type of flour (with appropriate procedural modifications), any additional spices or seasonings, or even the type of grain used in the production of the flour (whole wheat, gluten-free, etc.). Experiments in the production of the Sicilian delicacies panelle and sfingi demonstrate that even the use of flours with such exotic bases as chick peas and potato (as well as millet, peanuts, soy etc. in other experiments) obtain the same time-saving, cost-saving, labor-saving advantages as traditional white wheat flours. The addition of other items such as olive pieces, nut pieces, anchovies, salami, sesame seeds etc. has been shown to be consistent with the same cost-of-production advantages, making Squeezeeta suitable as a method of manufacturing everything from artisanal exotica such as pane alle olive to industrial-scale Big Mac buns.

For crêpes, pancakes, beignets, waffles and other specialty products that require eggs, we have shown that eggs can be easily added to the Squeezeeta mix of ingredients, as long as the extra liquid introduced by the eggs is taken into account when measuring the proportion of water. The same Squeezeeta one-step mixing process, producing a fluid, ready-to-use compound, is employed. The same principle is applied when additional oil/butter/shortening is called for in a recipe (e.g. for brioches, croissants etc.).

Squeezeeta provides a similarly advantageous (in terms of cost, time, labor, quality) method of producing pasta. A range of varieties of flour (white wheat, whole wheat, oat, spinach-added, tomato-added, etc.), including potato flour for the manufacture of gnocchi, can be mixed in the same economical one-step manner, using the same higher-proportion of water to other ingredients, and reduced or eliminated yeast, to produce a compound of the same fluidity and viscosity which is immediately ready to be used either by the food service producer or (once packaged and shipped) by the home consumer. Experiments have shown that the addition of eggs, in pastas such as pappardelle or tagliatelle, are perfectly suited to Squeezeeta production methods, when the additional liquid from the eggs is taken into account. The same is true of exotic flours based on chestnut, cauliflower, and gluten-free pastas such as pizzoccheri or bigoli, both based on buckwheat. Yet even the notoriously difficult-to-use buckwheat flour is made more convenient and economical, and palatable, by Squeezeeta. The use of additional herbs and spices—including eggs, oregano, peppers, olive oil, sugar, tomato, curry, parsley, ginger, spinach, cuttlefish ink, peas, carrots and broccoli—has been shown not to inhibit Squeezeeta's ease and economy of production in any degree, while of course adding to the product's nutrition and taste advantages. Similarly, the addition of dietary supplements such as vitamins, proteins, omega-3s, trace minerals etc. have been examined experimentally and have not been shown to affect the production efficiency of Squeezeeta. The consumer (or food service) use of the Squeezeeta compound for the making of pasta is described below in detail.

Here it should be pointed out that the production methods of Squeezeeta, and the benefits that accrue to large-scale manufacturers, can be used by food service producers (further down the logistical tree from manufacturers) and others, to reap the same advantages of lower cost and higher quality in exactly those areas most pertinent to each group. This includes chefs, caterers, restaurants, pizzerias, food service operators, fast food chains, banquet halls, food courts, food trucks, retirement homes, schools, daycare centres, churches, humanitarian organizations and emergency responders, prisons, military installations, or any private consumer in a private home. In all cases, without exception, the ease, economy and high quality (of both nutrition and taste) of Squeezeeta production offer innovative advantages that are not to be found in the pre-Squeezeeta marketplace of today.

Moreover, the ease of production of Squeezeeta gives it educational value which can be incorporated into school and community group programs to educate them, first, as to how to make pizza, but more broadly on the value of eating nutritious and delicious foods, while entertaining them and stimulating their creativity, sociability, interpersonal emotional intelligence, etc. In the same way, Squeezeeta can provide a vehicle for campaigns to disseminate a higher level of food consciousness in communities that need it, introducing such ideas as the culture of food, healthy eating, “slow food”, and the importance of nutritional quality and lifestyle to our everyday lifestyles. Squeezeeta offers ordinary consumers, both individuals and families, a way of making food more nutritionally, more personally and creatively, yet at the same time affordably—allowing them, though squeezed for time and disposable income as they are, to experience and appreciate the value of homemade pizza and pasta, authentic flavours, high quality nutrition, fresh food, and the satisfaction of preparing their own dinner just the way they want it, with the ultimate goal of achieving a more sustainable work-life balance.

Squeezeeta is therefore an innovative product that enables its own further innovative packaging opportunities, which are inherently a part of the Squeezeeta concept. Squeezeeta is particularly adapted to delivery in flexible pouches (in Europe, sac-à-poche), squeeze bottles, squeeze tubes, aerosols, or various types of soft-squeeze bottle currently used for mustard, ketchup or other condiment-foods. (The characteristic “squeezing” use of these kinds of packages epitomizes the brand name and concept of Squeezeeta—and in the case of the flexible pouch, the packaging lends itself to a triangular shape that speaks directly and visually to the consumer of the perfect pizza slice, as promised by the product itself.) The product may be marketed in different sizes/quantities, and either on its own or in a “kit” containing various basic add-ons, such as tomato, cheese, garlic etc.

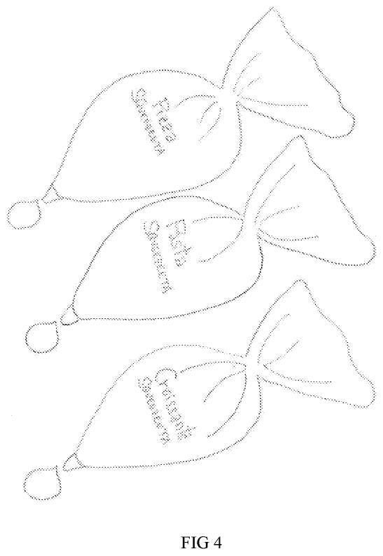

When the Squeezeeta product is used for products other than pizza dough (e.g. for pasta, breads, focaccia, panzerotti etc), the Squeezeeta squeeze-package concept applies in exactly the same way, with shape and package-printing chosen according to the nature of the final product (adding marketing value) [FIG. 4]. According to experiments conducted, manufacturers can adapt, for the purpose of packaging Squeezeeta with its particular fluidity and viscosity, existing technologies used in packaging products of similar viscosities, including in toothpaste and other cosmetics, as well as the dairy, cheese, yogurt, prepared sauces, or cured meat industries. In other terms, the filling technology necessary for handling this type of viscosity is already in commercial operation in the Food & Beverage and other sectors.

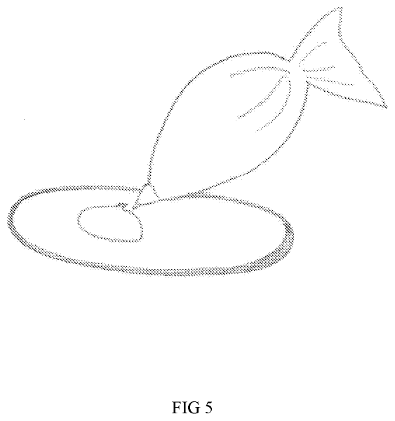

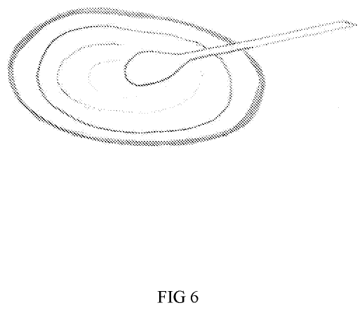

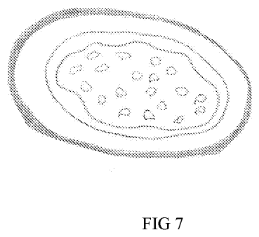

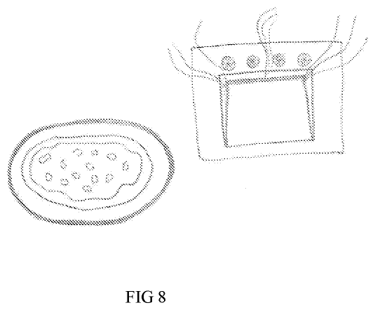

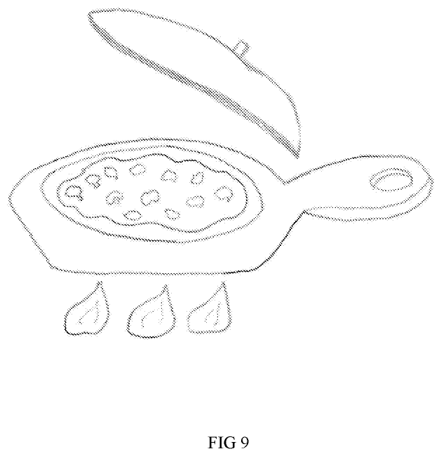

As mentioned, Squeezeeta also represents a new method of cooking of pizza (or other dough-based products). For the original Squeezeeta pizza product, the method of preparation by the home consumer is uniquely simple, and, once again, innovative. The compound is squeezed out directly onto a non-stick pan (or onto a base of flour or olive oil lubricating an ordinary pan) [FIG. 5] then smoothed out with a spoon to adjust shape, thickness and size as preferred [FIG. 6]. Toppings are placed directly on top of the compound [FIG. 7]. In particular, as the product is marketed for retail, basic toppings (such as tomato sauce and fiordilatte) could be provided in a Squeezeeta-kit (kits, in fact, are everywhere reported to be far more appreciated by consumers than stand-alone goods). Then the whole is inserted into an oven at 180° C. for 15 min (a minute or two more or less, depending on the thickness, the desired crispness, etc.) [FIG. 8]. We have also shown experimentally that the pizza can be cooked on a stovetop using a frying pan, pancake style, instead of in the oven (convenient for people who do not have an oven at home). In this case, the pan must be covered with a lid to ensure a uniform cooking of bottom and toppings. [FIG. 9]. In all oven-cooked cases, an ordinary home oven was used—no specialized or high-temperature equipment is required.

The benefits to the consumer are multiple. Preparation is fast and easy, requiring no special expertise, and produces a very delicious, homemade, authentic and psychologically satisfying hands-on meal, for oneself and one's family, rather than a store-bought ready-to-eat product. Squeezeeta is satisfying in terms of quality, and at the same time, more convenient in price (for lower costs of production) making personalized high-quality “slow food” more widely available and affordable. In addition, Squeezeeta is almost infinitely customizable in its make-up and in its shape. It can be squeezed into letters or numbers, heart-shapes, happy faces, etc., using pre-shaped pans, and it can be easily shaped into thick (sfincione: Sicilian high crust) or thin crust pizza versions. Even though members of the same family or household often prefer very different styles of crust, most pizzerias produces only a single type—Squeezeeta thus enables consumers a wider range of personal expression and preference, even within the same home. This will reduce the amount of waste, while offering a higher degree of satisfaction to consumers. And of course, consumers can each choose their own desired size by adjusting the amount of dough they squeeze out, a particular advantage for people on diets and weight control.

The same method of preparation of pizza can be used by food operators, with the same attendant advantages—the full range of customized Squeezeeta products all share this low-cost, higher-speed production process—available to food service companies, caterers, chefs, restaurants, pizzerias, fast food chains, banquet halls, food courts, food trucks, retirement homes, and other institutional food providers whether military, missionary, humanitarian, political, social, or based in churches, schools, hospitals, daycares, retirement homes, offices, or other social gatherings for any purpose. Moreover, professional food service companies with access to traditional high-temperature pizza ovens can reduce the cooking time from 15-minutes to 10 minutes or less.

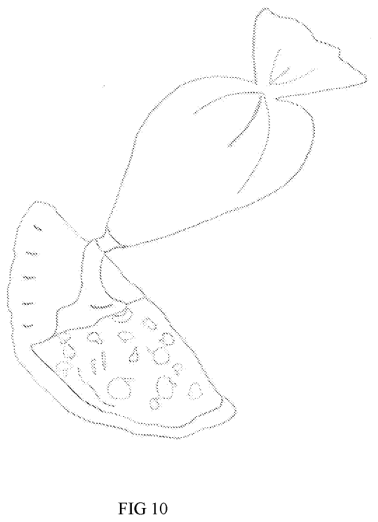

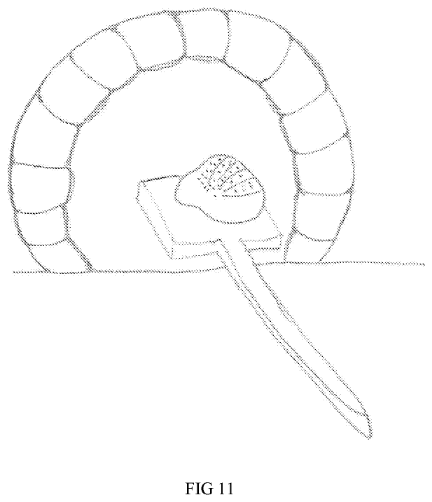

To prepare other specialty food products with Squeezeeta is equally fast and convenient. For calzone/panzerotto, the compound is squeezed onto a pan of the desired size and shape. Toppings are added directly on top, and another layer of dough is squeezed out on top of the toppings to seal them [FIG. 10]. The whole preparation is then put into the oven at 180° C. for 15 min. For breads, the compound is squeezed into a baking pan, sesame seeds or other seasonings, if desired, are added on top, and the whole is put into an oven at 180° C. for 15 min [FIG. 11]. Squeezeeta allows families to make their own bread on a just-in-time basis, avoiding the current creation of enormous quantities of wasted bread that does not get eaten in time.

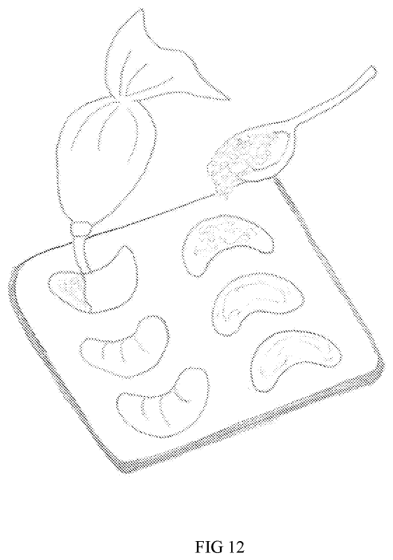

For focaccia, the consumer adds a bit of olive oil and rosemary on top of the compound and bakes as usual. For bruschetta, she dresses with toppings after the product comes out cooked from the oven. Both of these, as well as calzone and other products, can be cooked in a covered frying pan instead of in the oven. For crêpes and pancakes, the consumer uses a crêpe pan, with a thin layer of compound, thereafter following the traditional crêpe-making procedure. For croissants and brioches, the compound is placed in an appropriately shaped pan and put into the oven [FIG. 12]. This method can be used to produce delicious Sicilian brioches, which can be filled with ice-cream, or any other filling (nutella, peanut butter, cheese etc). This is an excellent way for moms to prepare snacks at home. For pasta, experiments have shown that a spoonful of dough (in the desired size) can be dropped into boiling water—the dough then condenses into its own shape and cooks for less than five minutes, after which it can be drained in a strainer and dressed as desired in a traditional or innovative manner. Using an enclosed strainer with holes (similar to a tea-infuser or “tea-egg” often used to brew loose-leaf tea), in which the dough is boiled, it is possible to produce equally-shaped bits of pasta. Different shapes and sizes of the same filter/enclosed strainer can produce the desired shape and size of pasta. Or, by not using an enclosed strainer but dropping the uncooked pasta dough directly into the boiling oil or water, each piece of pasta will come out with a slightly differently shape, adding an artisanal, hand-crafted and non-industrial character to the resulting product.

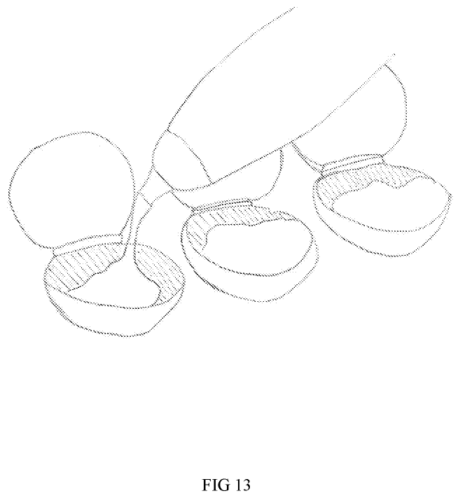

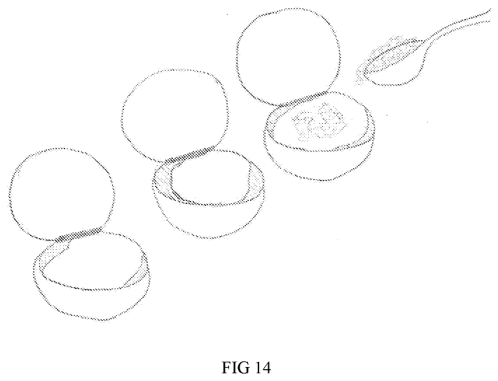

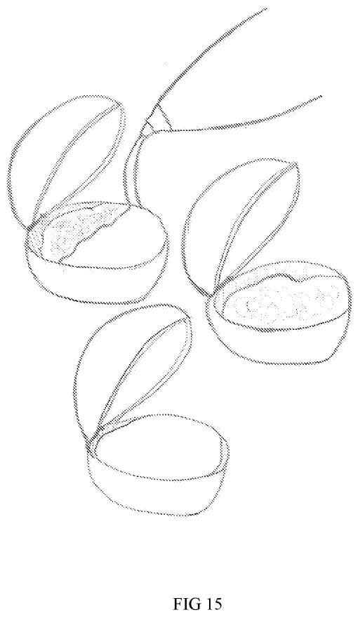

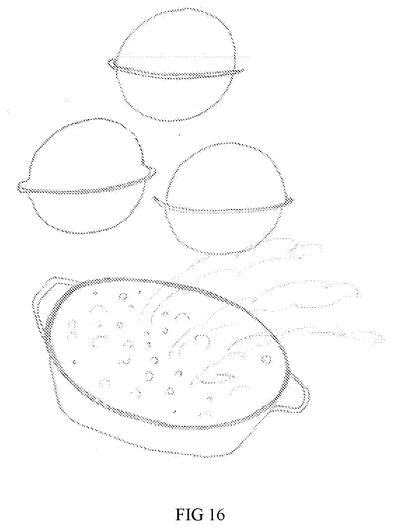

With this use of an enclosed strainer, the home-cooking consumer can make filled pasta [FIG. 13], with any type of filling (e.g. ricotta and spinach, pumpkin, cream cheese, ragu, etc.) to produce a faster, easier and more economical dish of ravioli, tortellini and so forth. The filling is squeezed directly onto a layer of dough [FIG. 14], after which a second layer of dough is squeezed out on top [FIG. 15]. Then the strainer is closed and immersed in boiling water [FIG. 16]. When a number of strainers are immersed at once, with many pieces of pasta, the process is accelerated. Otherwise, if each piece is immersed one by one, each one can be just partially cooked, enough to allow both compound and filling to solidify—so that once all the pieces have been pre-cooked, they can be boiled again together to produce a complete meal at the same time. Shaped pans can also be used to make filled pasta in the oven, using all sort of fillings (like Italian cannelloni, crepes pasta, or ravioli). In this way, Squeezeeta provides an innovative, convenient and economical way to produce a wide range of filled or unfilled food products for meals and snacks, in a way superior to current and traditional methods.

The same compound (made with any flour desired, as discussed above) can also be deep-fried in the form of little drops of dough to create salty snacks to eat with the consumer's choice of dips, creams, etc. Sweet snacks can be created by deep frying drops of dough, draining them, cooling them, and dressing them with different sweet toppings. With sugar and honey, one can create a faster version of the Sicilian sfingi and pignolata pastries, as well as other ethnic treats. By leaving them to deep fry for a longer period, a crunchier product is produced which, when covered in sugar, produces a new version of the Italian pastry chiacchere.

Using an enclosed strainer (similar to tea-infuser or “tea-egg”), Squeezeeta makes it very easy and convenient to produce the otherwise difficult and challenging Italian delicacy known as arancini—one layer of Squeezeeta dough is squeezed into the enclosed, the arancini filling is placed on top of this layer, then a second layer of dough is squeezed out to cover the arancini filling. The result is then immersed in a deep fryer. It is similarly quicker and easier to make other tasty snacks with Squeezeeta, filled in a variety of ways, such as Sicilian iris, ravazzate, genovesi (following the same procedure as arancini, except with a filling that is ricotta-based, or with pistachio cream or chocolate or anything the consumer chooses), Sicilian calzoni (filled with butter and prosciutto, ragù, or ricotta and spinach), or any other filling the consumer desires.

In marketing terms, Squeezeeta represents an absolute novelty in the packaged good category—a squeezable pizza dough, easy and convenient for the consumer to prepare, and completely customizable to individual tastes, which delivers a higher quality food experience at a lower cost than competing products. In fact, it enables consumers to prepare a fresh gourmet pizza (homemade style, with a complete choice of size, shape and crust thickness) in two single actions: first, squeezing out the dough—and second, covering it with their choice of toppings. Then they simply slide the pan into the oven for about 15 minutes. The result is better than frozen pizza (for price, nutrition and taste), prepared pizza crust (for price and taste), traditional pizza dough balls (for price, time, effort and expertise—Squeezeeta can be made by kids), and even pizza at restaurants or delivery (for price). Additionally, Squeezeeta is better than all of the above, for it is the first pizza that is totally customizable by the consumer. Consumers can choose their own preferred shape (by squeezing out the compound in a way to create a shape or a text or a work of art), their own preferred size (by squeezing out the quantity of dough they desire, a factor particularly suited for people on diets and weight control) and their own preferred crust thickness (by simply squeezing out and spreading a thinner or thicker layer onto the pan). Unlike existing products, Squeezeeta also has a very high and important emotional value: fun! The product invites group participation—families and friends, kids, students and adults, all find its totally new squeezing feature instantly entertaining, stimulating imagination, laughter, jokes and creativity.

Following, here, is a list of criteria showing why Squeezeeta represents a valuable solution to many existing market issues. First of all, time. Today to prepare pizza, homemakers and professionals need to follow a step-by-step process, which is difficult and time-consuming. The highly elastic needs to be carefully spread out without tearing, as holes must be repaired before toppings can be added. Ingredients need to be added one at a time, and worked out separately before being mixed together. In mass production, this step-by-step process requires a complex assembly line, with high cost, and a high rate of obsolescence. Long-term resting and leavening is also necessary for quality and digestibility purposes. Result: lower productivity plus increased costs of production for manufacturers and food services. The same difficulties on a smaller scale discourage consumers from buying traditional pizza dough balls—lengthy preparation methods are incompatible with consumers' time-short lives. In sharp contrast, Squeezeeta's method of production is a one-step process. All ingredients are added and mixed together at the same time. The product is ready to bake and consume immediately after mixing. The assembly line shortens, and costs fall. Final consumers can prepare a pizza from scratch in record time.

Also, current methods to produce a pizza from scratch at home require expertise in handling the dough without breaking the fiber. In manufacturing, this calls for advanced technologies and, in food service, the employment of highly skilled professionals, at a higher cost in terms of compensation, training and hiring. With Squeezeeta, pizza production, in factory or at home, becomes so easy that kids can do it.

With current methods, manufacturers have to invest in technologies to speed up production as much as possible. Food services have to invest in highly skilled “pizzaioli”. Cost of capital and labour is reflected in the final price. Conversely, the cost for producing Squeezeeta is much lower, driving down the market price to a new minimum.

Pizza today comes in obsolete traditional packaging. Frozen pizza, pizza for delivery, pizza crust, pizza dough balls—they all come in cardboard boxes or plastic wrapping or both. These packaging methods are heavy and cumbersome, affecting transportation costs and logistics in stores and warehouses, reducing revenue from sales and distribution. They also have an impact on the environment—a fact to which consumers are becoming increasingly sensitive. Thanks to its fluid nature, Squeezeeta can be packaged in pouches (like a baker's sac-à-poche) with higher levels of space optimization, lighter weight, and eco-sustainability. Squeezeeta could even be offered at self-serve stores, through spouts (like beer taps in a bar, or filtered drinking water) and self-packaged by consumers. While cutting costs and reducing environmental impact, final consumers would gain even more ability to personalize their Squeezeeta.

Modes of preparation are a crucial consideration today for manufacturers—traditional pizza dough balls really require high-temperature ovens for best results, but few home-ovens are of this kind. This is why producers offer pre-baked pizza crusts—despite a considerable sacrifice in taste and freshness. Others prescribe the best oven to use, and even supply it themselves—but very few consumers will be financially equipped to take advantage of the offer. On the other hand, Squeezeeta, thanks to its fluid nature, is more responsive to heat, and cooks well in any home oven, requiring no professional equipment to prepare a delicious, restaurant-quality meal.

The paradox of pizza is that, while almost everyone around the world likes it, they all like it in a different way—thick or thin crust, harder or softer, round or square, small, medium, large. Even in the same family, pizza preferences can differ. How well does today's market accommodate these different tastes? Not well at all. The market is filled with all sorts of pizza in an effort to pre-satisfy all tastes. But there is no single pizza product that is entirely adaptable and customizable by the consumer. The only way to suit different tastes in the family is to buy different pizza brands—wasting both time and convenience. Now thanks to Squeezeeta, this is no longer the case—Squeezeeta makes every pizza's shape, size, crust thickness etc. totally responsive to each and every consumer's creativity and discretion. Squeezeeta makes pizza 100% personalized.

Currently available pizza products, such as frozen pizzas, have been perceived by consumers as less nutritious, and are often assumed (and often with reason) to contain high levels of sodium and preservatives. This consumer perception is projected to increasingly hamper market growth, as consumers grow more conscious of, and sensitive to, the nutritional quality of their foods. Squeezeeta directly answers this growing consumer demand for quality and nutrition. It is not pre-cooked—the dough cooks at the same time of the toppings—preserving freshness and taste and eliminating nearly all need for additives and undesirable ingredients.

Market research shows that younger generations, especially millennials, are not as attracted to frozen pizzas, which lack innovation and are perceived as commodity products. Many companies today, conscious of the enormous size of the frozen pizza market, are funding new R&D to develop a new, more modern and hip image for their pizza products, to better engage these rising young consumers. Squeezeeta, by its very nature, provides the innovation, convenience, cost and quality to bring pizza into a new dimension, for millennials around the world.

Squeezeeta is an innovation not just in the pizza industry but in the whole food market, beyond individual food categories—for it is not just “slow food”, and not just fast food. It is the first real example of slow food fast, a new third way beyond both existing categories. Most people don't have the time for slow food, and many don't have the budget either. But they do have the intelligence and sensibility to appreciate it, and aspire to it. Squeezeeta is the only pizza product that enables individuals and families to balance their busy work lives with a richer, more satisfying food experience that they never had the time for before. This aspect adds to Squeezeeta's appeal to bigger shares of the market, the most conscious and demanding consumers (who tend to lead consumer trends), those most concerned with health, quality, freshness, image, body fitness and lifestyle. For the same reason Squeezeeta would immediately connect with the latest generation of newcomers from Europe to North America—one of whom is the inventor of the product!—culturally more concerned about food quality than previous generations of North Americans, and resistant to the lure of junk food chains and retailers.

Yet Squeezeeta's appeal is not limited to hipsters and young people. Indeed, its first target market is moms with kids, by far the largest portion of the food-buying consumer base, for whom Squeezeeta offers numerous obvious benefits—convenience, time-saving, popularity with kids, nutrition for her family, etc. Inside the store, Squeezeeta fits within multiple categories: party and special occasions, kids' foods and snacks, “ready to eat” products—yet also gourmet foods, natural fresh ingredients, weight control-friendly products, students, young singles and professionals' meals. Squeezeeta can easily be developed in a number of segmented “lines”—from gluten-free, low-calorie, high-fiber whole-wheat, or high-protein chickpea flour or soy, to the most exclusive lines, such as chestnut flour. Each line too can be presented in a number of versions—by adding spices (fennel seeds, hot spices, oregano, basil etc)—for everybody's taste and imagination.

But—beyond the consumer market—Squeezeeta is an invention that can also deliver significant cost savings (in terms of time, training, wages etc.) to pizzerias and restaurants, if suitably packaged as an input of production in their kitchens. These businesses would be happy to switch their operations and processes over to Squeezeeta, in return for increased productivity and lower costs, as well as the higher quality of their pizzas.

Squeezeeta, with its high level of consumer attractiveness, and its low cost of production, hits that rare sweet spot for packaged goods—the place with the highest profitability. Unlike most products, which are either high-volume/low-margin such as sugar or salt, or low-volume/high-margin like cars or houseboats, Squeezeeta can find that magical space of high-volume/high-margin, usually only found historically in products like soda pop, cigarettes, oil—in other words, the most profitable products ever sold.

What is claimed is:

1. A method of producing/manufacturing a squeezable pizza dough (or other types of dough), comprising the following steps:
step one—importing all the ingredients into the same mixing machine;
step two—including a greater percentage of water (60-to-90% relative to grain/flour) such that the total quantity of fluids confers higher-than-usual fluidity to the resulting dough, the viscosity of which will resemble that of commercial toothpaste;
step three—mixing all ingredients together at once (thus eliminating the need to employ a complex industrial assembly process, or to release ingredients at different moments in the process, and at different rates);
step four—inserting the resulting viscous dough into a squeezable package, such as a commercial pouch (a “sac-à-poche”, resembling the icing-pipe used to decorate cakes);
step five—sealing up the package, resulting in a self-contained packaged good, ready to be shipped and marketed to retail consumers, or to commercial food services clients.
step six—freezing or refrigerating the packaged good.

2. The method of claim 1, further comprising: varying the “ingredients” mentioned at step one, according to the particular dough one wants to prepare (e.g. dough for bread, pasta, focaccia, croissants, crepes, etc.); accounting, at step two, not only for water but for all liquid ingredients conceived by the specific recipe (e.g. eggs, milk, creams, olive oil etc.)

3. The method of claim 1, further comprising: varying the “ingredients” mentioned at step one, in order to make multiple lines or versions of the same dough (whether pizza dough, or different types of dough)—making for instance a line with whole-grain flour, another with gluten-free flour, or with added vitamins or proteins, or with various spices (cinnamon, pepper, etc.)

4. The method of claim 1, further comprising: using, at step four, sac-à-poche of different sizes and formats, in order to market the product for both retails and food services.

5. The method of claim 1, further comprising: after step six, transporting the sac-à-poche to ad-hoc facilities, equipped with refrigerated tanks and connective tubes departing from the tanks up to a number of spouts; reversing Squeezeeta dough from the sac-à-poche into the tanks; channelling the dough throughout the tubes, in order to feed all spouts; having consumers operate the spouts, in order to fill their own self-provided packages with Squeezeeta dough, in a self-service fashion.

6. A method of cooking a squeezable pizza (or other dough-based products), comprising the following steps:
step one—squeezing the dough directly onto a pan or cooking sheet (a non-adherent type or lubricated with cooking oil or flour);
step two—adjusting size, shape and thickness of the squeezed dough, for total consumer customization;
step three—adding, any desired toppings (whether liquid such as tomato sauce or pesto, or solid such as mozzarella, mushrooms etc.), directly onto the squeezed compound;
step four—putting the whole resulting confection under heat (e.g. oven, at 180° C. for 10-15 minutes)

7. The method of claim 6, further comprising: using, at step four, a common kitchen-oven, found in most residences—with no need for professional equipment or for any high-temperature heating capabilities such as a commercial pizza oven.

8. The method of claim 6, further comprising: between steps three and four, squeezing an extra layer of dough directly on top of the applied toppings, in order to make calzoni or panzerotti—the two layers of dough fusing together under heat during cooking time, to contain the toppings, functioning now as filling.

9. The method of claim 6, further comprising: choosing appropriate toppings at step three, in order to make focaccia or bread (e.g. salt, olive oil and rosemary in the case of focaccia—and sesame or other seeds or desired toppings, in the case of bread).

10. The method of claim 6, further comprising: using appropriate sweet or savory toppings at step three (e.g. jam, chocolate cream, mustard, cheese, bacon, eggs etc) and squeezing an extra layer of dough directly on top of the applied toppings, between steps three and four. This is in order to make a sweet or savory pastry—where the two layers of dough seal up under heat during cooking time to contain the toppings, functioning now as filling.

11. The method of claim 6, further comprising: using a molded “pan” at step one, and squeezing, between steps three and four, a second layer of dough directly on top of the toppings, in order to make filled brioches (such as croissants, arancini etc.)—sweet or savory, depending on the selected filling.

12. The method of claim 6, further comprising: squeezing the dough directly onto a frying pan at step one and, at step four, putting the frying pan onto the stovetop for 20 minutes to cook (rather than in the oven), covering the pan with a lid to maintain consistent heat.

13. The method of claim 6, further comprising: squeezing, at step one, a thin layer of dough onto a frying pan and, at step four, putting the pan on the stove to cook for 15 minutes, then flipping the resulting crust back and forth for an additional 5 minutes, till optimal crispiness is obtained, then folding it, dressing it as desired, and serving it on a plate, in this way making traditional crêpes in an innovative way.

14. Method of cooking squeezable fresh pasta (or other dough-based products), comprising the following steps:
step one—squeezing the dough directly into a set of enclosable strainers (resembling the “tea egg” used to brew loose-leaf tea);
step two—closing up the strainers containing the dough;
step three—immersing the strainers into a hot fluid (such as boiling water) for 3-4 minutes;
step four—removing the strainers and releasing the pieces of fresh pasta into a serving container to be dressed or marinated.

15. The method of claim 14, further comprising: using, at step one, strainers of various shapes (square, round, polygonal etc.) in order to create fresh filled pasta in all cuts and formats, whether traditional or non-traditional.

16. The method of claim 14, further comprising: applying, between steps one and two, the desired filling for pasta and squeezing a second layer of dough to cover it, in order to make filled fresh pasta (such as ravioli, tortellini, agnolotti, medaglioni etc.)

17. The method of claim 14, further comprising: immersing, at step three, the strainers into hot cooking-oil (instead of boiling water) and, at step four, appropriately dressing the so-obtained pieces of deep-fried pasta to create popular sweet dishes (such as the Sicilian pignolata, with honey, or chiacchere and sfingi, sprinkled with sugar, etc.)

18. The method of claim 14, further comprising: applying, between steps one and two, the desired filling and squeezing a second layer of dough overtop to cover it; immersing the strainers, at step three, into hot cooking oil (instead of water) in order to make traditional filled sweets (such as the Sicilian iris and cassatelle, filled with ricotta, or arancini filled with meat ragout or cheese or bombe, filled with nutella etc).
